(19) United States
(12) Patent Application Publication
(10) Pub. No.: US 2007/0190990 A1
(43) Pub. Date: Aug. 16, 2007

(54) CONFIGURING SERVICE DATA USING A MOBILE UNIT

(76) Inventor: Alexander Aihao Yin, Qing Dao (CN)

Correspondence Address: WILLIAMS, MORGAN & AMERSON, 10333 RICHMOND, SUITE 1100, HOUSTON, TX, 77042, US

(21) Appl. No.: 11/457,923

(22) Filed: Jul. 17, 2006

(30) Foreign Application Priority Data
Feb. 10, 2006 (CN) 200610082100.9

(51) Int. Cl. H04Q 7/22

(52) U.S. Cl. 455/414.3

(57) ABSTRACT

The present invention provides a method for managing service data over an air interface. The method includes receiving, from a mobile unit, a request associated with information indicative of service data associated with the mobile unit and providing the request associated with the information indicative of the service data associated with the mobile unit to a server that is configured to store the information indicative of the service data.

This patent application claims priority to the previously filed Chinese Application No. 200610082100.9 which was filed with the Chinese Patent Office on Feb. 10, 2006

### BACKGROUND OF THE INVENTION

1. Field of the Invention

This invention relates generally to communication systems, and, more particularly, to wireless communication systems.

2. Description of the Related Art

Second generation wireless communication systems and networks are evolving to wireless communication systems and networks that operate in accordance with third generation (3G) wireless communication standards, such as the wireless communication standards for UMTS defined by the Third Generation Partnership Project (3GPP) and the wireless communication standards for Code Division Multiple Access (CDMA) defined by the Third Generation Partnership Project-2 (3GPP2). For example, the 3GPP 33.203 and the 3GPP2 S.R0086 specifications define an Internet Protocol (IP) Multimedia Subsystem (IMS) that defines standards for using a signalling protocol called the Session Initiation Protocol (SIP). The SIP is the official protocol used to support various multimedia services that are provided to a mobile unit. Exemplary IMS services include Internet conferencing, Internet telephony, video telephony, event notification, instant messaging, and the like.

Conventional 3G communication systems provide IMS services to one or more IP Multimedia User Equipments (UEs), which may also be referred to as mobile units, user terminals, access terminals, and like. A UE may establish a call session with the first entry node of the IMS network, e.g., a Proxy Call Session Control Function (P-CSCF) for the establishment, maintenance and termination of Point to Point Protocol (PPP) sessions that may be communicatively coupled to a Home Subscriber Server (HSS) that provides data base functions, a Server Call Session Control Function (S-CSCF) that provides session control services, and an Application Server (AS), as well as other devices. The Application Server may provide the IMS services to the UE according to service data associated with the UE and stored on the Home Subscriber Server. For example, the Application Server may provide call forwarding services, do-not-disturb services, call waiting services, and the like based on service data associated with the UE.

Users may want to modify their service data, e.g., due to changing circumstances. For example, a user may want to initiate call forwarding to a landline phone and specify the telephone number of the landline phone when the user expects to be near a landline phone. However, conventional UEs do not allow users to specify and/or modify service data associated with the UE over the air interface. Instead, users must specify and/or modify service data using some other external path. For example, in 3G systems, subscriber service data are centrally stored in the Home Subscriber Server. The Application Server may access and/or modify the service data on the Home Subscriber Server via a predefined interface. If a user wants to specify and/or modify service data, the user must access the Application Server or the HSS using a path other than the SIP air interface, such as an operator help-desk, an interactive voice responder, a browser or web server, and the like.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, methods are provided for managing service data over an air interface. One embodiment of the method includes receiving, from a mobile unit, a request associated with information indicative of service data associated with the mobile unit and providing the request associated with the information indicative of the service data associated with the mobile unit to a server that is configured to store the information indicative of the service data. Another embodiment of the method includes providing, from a mobile unit, a request associated with information indicative of service data associated with the mobile unit and receiving a response message indicating that the information indicative of the service data has been provided to a server that is configured to store the information indicative of service data.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates one exemplary embodiment of a mobile unit including a user interface for display and/or modification of service data, in accordance with the present invention;

FIG. 3 shows exemplary SUBSCRIBE and NOTIFY messages, in accordance with the present invention;

FIG. 4 conceptually illustrates one exemplary embodiment of a method of retrieving service data, in accordance with the present invention;

FIG. 5 conceptually illustrates one exemplary embodiment of a method of modifying service data, in accordance with the present invention; and

FIG. 6 conceptually illustrates one exemplary embodiment of a method of notifying a mobile unit that service data has been modified, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i. e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

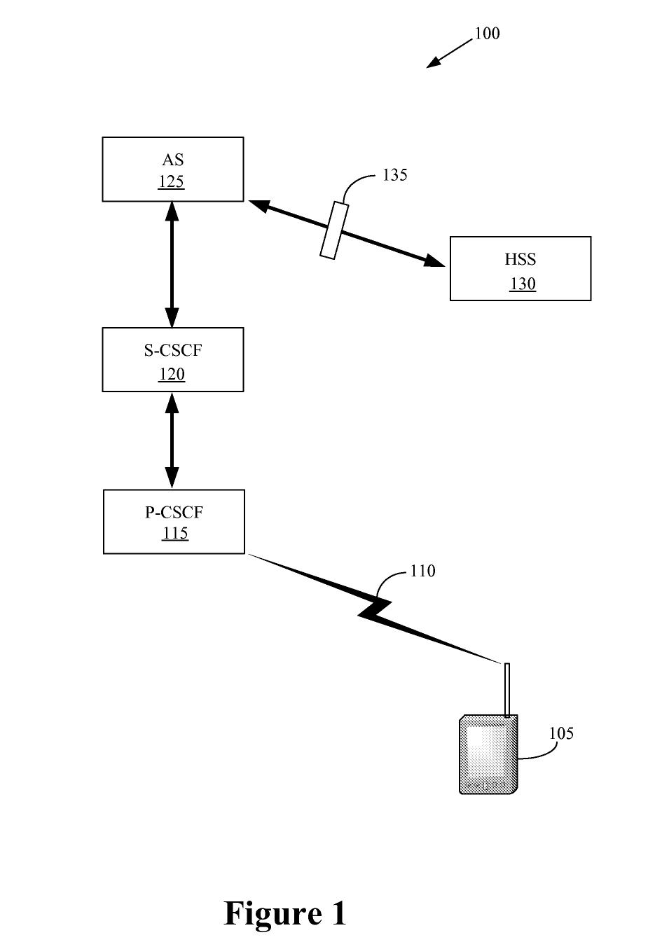

FIG. 1 conceptually illustrates one exemplary embodiment of a wireless communication system 100. In the illustrated embodiment, the wireless communication system 100 provides wireless connectivity in accordance with third generation (3G) wireless communication standards, such as the wireless communication standards for UMTS defined by the Third Generation Partnership Project (3GPP) and the wireless communication standards for CDMA defined by the Third Generation Partnership Project-2 (3GPP2). In one embodiment, the wireless communication system 100 may provide wireless connectivity in accordance with an Internet Protocol (IP) Multimedia Subsystem (IMS) that defines standards for using the Session Initiation Protocol (SIP) to support various multimedia services. However, persons of ordinary skill in the art having benefit of the present disclosure should appreciate that the present invention is not limited to wireless communication systems 100 that operate only in accordance with the aforementioned systems and/or protocols.

In the illustrated embodiment, a wireless communication system 100 provides wireless connectivity to one or more mobile unit 105 over one or more air interfaces 110. For example, the wireless communication system 100 may provide wireless connectivity to the mobile unit 105 over one or more SIP air interfaces 110 that operate according to SIP protocols. In the interest of clarity, one mobile unit 105 and a single air interface 110 are shown in FIG. 1. However, persons of ordinary skill in the art having benefit of the present disclosure should appreciate that the present invention is not limited to any particular number of mobile unit 105 and/or air interfaces 110. The mobile unit 105 may be any type of mobile unit including, but not limited to, a cellular telephone, a personal data assistant, a smart phone, a network interface card, a laptop computer, a desktop computer, and the like. Persons of ordinary skill in the art should also appreciate that the mobile unit 105 may be referred to using other terms such as mobile shell, user equipment, user terminal, access terminal, and the like.

The air interface 110 may connect the mobile unit 105 to a first entry node 115 of the wireless communications system 100. In the illustrated embodiment, the first entry node is a proxy call session control function (P-CSCF) 115, which is communicatively coupled to a server CSCF (S-CSCF) 120, an Application Server (AS) 125, and a Home Subscription Server (HSS) 130. The P-CSCF 115, S-CSCF 120, AS 125 and HSS 130 are known in the art and in the interest of clarity only those aspects of the operation of these elements that are relevant to the present invention will be described further herein. Furthermore, persons of ordinary skill in the art having benefit of the present disclosure should appreciate that, in alternative embodiments, the first entry node 120 may be coupled to more, fewer, and/or different elements of the wireless communication system 100. For example, the wireless communication system 100 may include one or more interrogating CSCF units that may be responsible for registration, routing and forwarding of SIP messages and charging.

The Application Server 125 may provide one or more applications and/or services to the mobile unit 105 over the air interface 110. In one embodiment, the Application Server 125 is an IMS application server that may run IMS service logic for IMS subscribers. Exemplary services may include call forwarding, call waiting, a do-not-disturb function, and the like, as well as IMS services such as Internet conferencing, Internet telephony, video telephony, event notification, instant messaging, a buddy list, a black list, and the like. However, persons of ordinary skill in the art having benefit of the present disclosure should appreciate that the present invention is not limited to these exemplary services.

The Application Server 125 may provide one or more services to the mobile unit 105 in accordance with service data. As used herein, the term “service data” will be understood to refer to any information that may be used to configure and/or provide a service to a mobile unit 105 and/or the end-user of the mobile unit 105. For example, service data may include information indicating that the end-user would like all calls directed to the mobile unit 105 to be forwarded, as well as information indicating a forwarding device, telephone number, Internet address, and the like. For other examples, service data may include information indicating that the call waiting function is enabled, information indicating that the end-user of the mobile unit 105 does not want to be disturbed and that calls should be directed to voicemail, as well as information used to configure and/or provide one or more IMS services. In embodiments that include a buddy list and/or a black list, users can define the buddy/black list, add buddy/black numbers into the list, and/or remove buddy/black numbers using this interface. The user may also be able to invite all (or some selected) members of the buddy list to join the voice/video conference by dialing to the buddy alias SIP address instead of inviting each buddy one by one. Incoming calls from numbers in the black list may be blocked by the application server 125. However, persons of ordinary skill in the art having benefit of the present disclosure should appreciate that these exemplary types of service data are intended to be illustrative and not to limit the present invention.

Service data may be stored in the Home Subscription Server 130. In one embodiment, the Home Subscription Server 130 may maintain a database including service data associated with mobile unit 105 and/or end-users of the mobile unit 105. For example, the Home Subscription Server 130 may include a database of subscriber service profiles that include information such as a registration data, service filter criteria, service data, location data, and the like. The database may be indexed by, among other things, a subscriber identifier such as an International Mobile Subscriber Identifier (IMSI). The Home Subscription Server 130 may also support one or more interfaces 135 for querying and/or updating the subscriber service data. In the illustrated embodiment, the Home Subscription Server 130 supports a Sh interface 135 between the Application server 125 and the Home Subscription Server 130. The Sh interface 135 is defined by the third generation standards such as the 3GPP and 3GPP2 standards.

The mobile unit 105 is configured to provide information over the air interface 110 that may be used to configure and/or modify service data associated with the mobile unit 105 and/or an end-user of the mobile unit 105. For example, SIP defines subscription and notification messages that may be used to transmit different types of information over the air interface 110. The type of information contained in the subscription/notification messages, as well as any actions indicated by the information in the subscription/notification messages, may be indicated by an “Event Type” that may be specified within a header of the subscription/notification message. The SIP subscription and notification messages are typically referred to as SUBSCRIBE and NOTIFY messages. The SUBSCRIBE and NOTIFY message bodies may be formed and/or parsed using the eXtensible Markup Language (XML) code, e.g. as defined by the IMS standards.

In the illustrated embodiment, the mobile unit 105 may support subscription/notification messages for a “service-data” event type. The service-data event type indicates that the corresponding subscription and/or notification message includes information that may be used to request/provide service data associated with the mobile unit 105, to configure service data associated with the mobile unit 105, and/or to modify service data associated with the mobile unit 105, as will be discussed in detail below. In one embodiment, the mobile unit 105 may be configured to compose eXtensible Markup Language (XML) code for service data subscription/notification messages in a SUBSCRIBE message body and to parse service data subscription/notification messages received in a NOTIFY message body, e.g. as defined by the IMS standards. Detailed descriptions of particular embodiments of the SUBSCRIBE and/or NOTIFY messages for the service-data event type are provided below.

The mobile unit 105 may also support various authentication and/or maintenance functions related to the service. For example, the mobile unit 105 may support authentication validation for the service configuration subscriptions. The mobile unit 105 may also accumulate and organize service data from different application servers, as well as storing and/or refreshing the service data on local storage. The mobile unit 105 may further be configured to refresh subscriptions for any service configurations within a selected subscription interval. In one embodiment, the mobile unit 105 may provide a user interface for dynamic display and modification of service data.

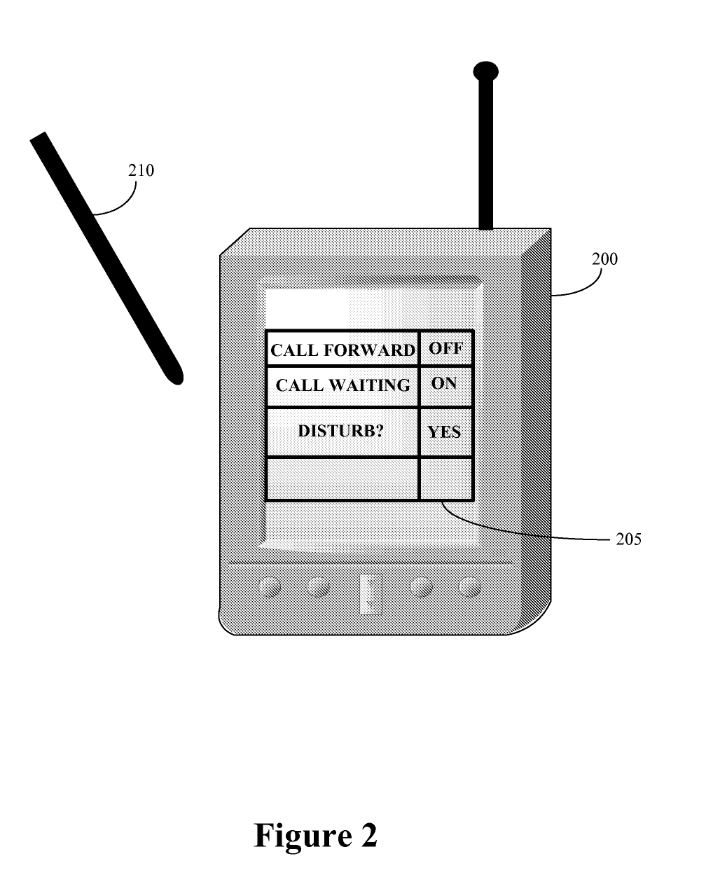

FIG. 2 conceptually illustrates one exemplary embodiment of a mobile unit 200 including a user interface 205 for display and/or modification of service data. In the illustrated embodiment, the user interface 205 displays a portion of the current service data. For example, the user interface 205 indicates that a call forwarding service has been turned off, a call waiting service is turned on, and the do-not-disturb service is configured to allow calls to be routed to the mobile unit 200. In one embodiment, the user interface 205 may also be used to modify the current service data. For example, a pointing device 210 may be used to select one of the services for modification. Techniques for operating a graphical user interface and/or a pointing device are known to persons of ordinary skill in the art and, in the interest of clarity, will not be described further herein.

Referring back to FIG. 1, the mobile unit 105 may provide a request (e.g., in a subscription message) including the information over the air interface 110 to the P-CSCF 115 which may forward the information to the S-CSCF 120. The P-CSCF 115 may be the first contact point within the IMS system and may therefore transmit SIP messages between the mobile unit 105 and the S-CSCF 120. The S-CSCF 120 may perform session control services for the mobile unit 105 and may maintain a session state for support of the services. The S-CSCF 120 may also decide whether the Application Server 125 is required to receive information related to an incoming SIP session request for service handling. The P-CSCF 115 and/or the S-CSCF 120, as well as any other CSCF units in the wireless communication system 100, may be configured to recognize “service-data” in the “Event-Type” header of the SUBSCRIBE and NOTIFY messages and their corresponding responses. The “service-data” event type indicates support for one or more embodiments of the service data configuration techniques described herein.

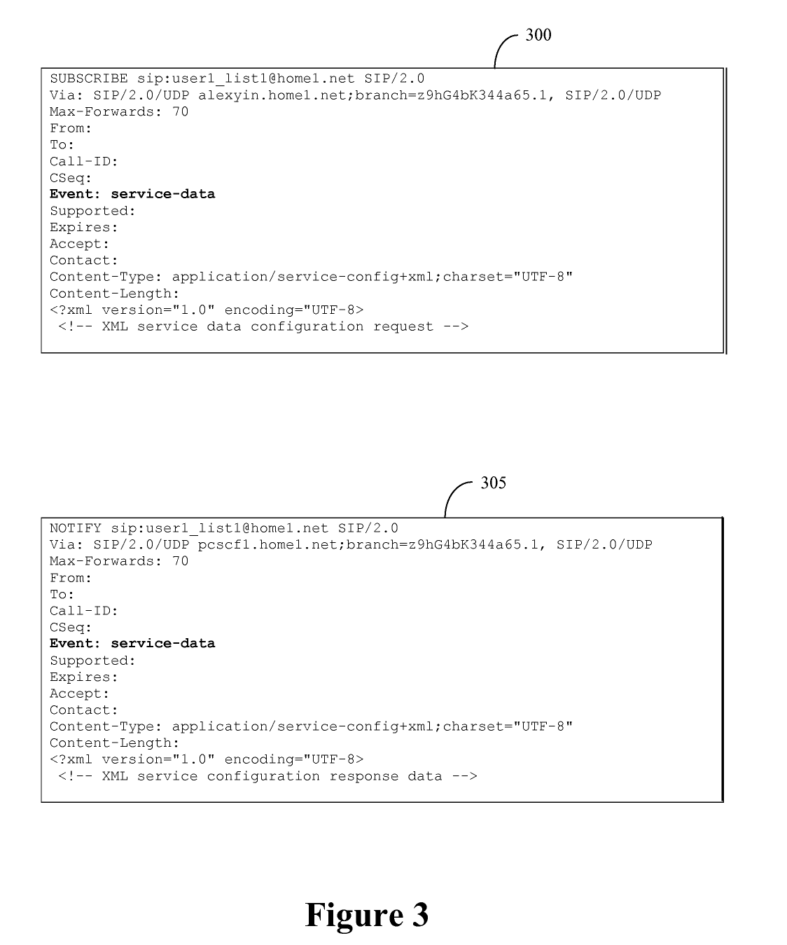

The SUBSCRIBE and/or NOTIFY messages may, in some embodiments, be implemented using XML. For example, XML scripts may be used to carry the service data and related operations in the body of the SUBSCRIBE/NOTIFY messages. The name for use in the Content-Type header may be: application/service-config+xml. In one embodiment, the P-CSCF 115 and/or the S-CSCF 120 may be configured to forward the SUBSCRIBE and/or NOTIFY messages to the appropriate destination with the XML body of the message unchanged. Conventional S-CSCF functionality may support forwarding the SUBSCRIBE message for service configuration to the application server 125 according to initial filter criteria (IFC) associated with the mobile unit 105 and/or an end-user of the mobile unit 105. Exemplary SUBSCRIBE and NOTIFY messages 300, 305 are shown in FIG. 3.

The Application Server 125 may provide information indicative of the service data to, or receive information indicative of service data from, the Home Subscription Server 130 via the interface 135. In one embodiment, the Application Server 125 may support a Sh interface 135 to the HSS for subscriber data retrieval and modification. The Application Server 125 may also support the SUBSCRIBE/NOTIFY procedures for the “service-data” event type described above. The Application Server 125 may perform a mapping operation to convert between the SIP “service-data” events and Sh messages. For example, the Application Server 215 may parse an XML request in the body of a SUBSCRIBE message and map it to one or more Sh requests that may be provided to the Home Subscription Server 130 via the interface 135. The Application Server 125 may also compose an XML response that may be transmitted to the mobile unit 105 in the body of a NOTIFY message using information included in a Sh response. The Application Server 125 may further form Sh notification messages and control authentication of a service configuration subscription and manage operation session timeouts.

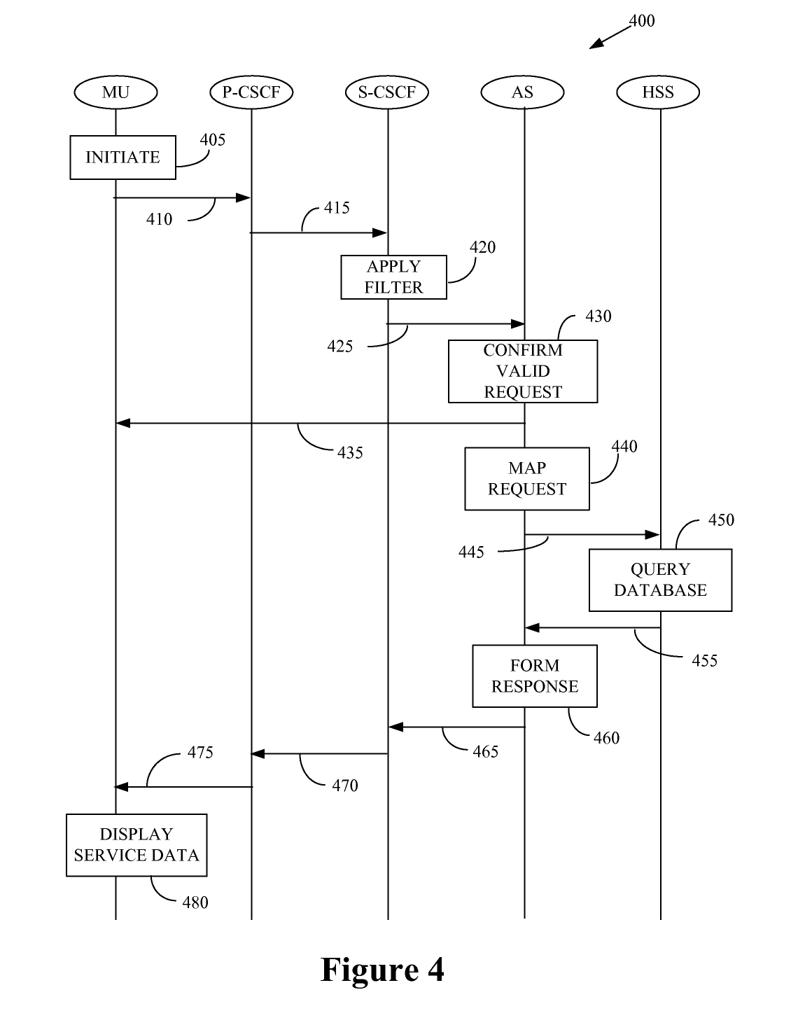

FIG. 4 conceptually illustrates one exemplary embodiment of a method 400 of retrieving service data. In the illustrated embodiment, a subscriber (or end-user) enters (at 405) information into the service configuration interface on a mobile unit (MU) to trigger downloading of service data from a home subscription server (HSS). For example, the subscriber may tap a portion of a graphical user interface using a pointing device or stylus to initiate (at 405) downloading of service data. The mobile unit may then provide a message indicating the request to download the service data, as indicated by the arrow 410. For example, a mobile unit may send a SUBSCRIBE message including a XML request to a P-CSCF, which may forward the SUBSCRIBE message to assigned S-CSCF, as indicated by the arrow 415.

The S-CSCF may then apply (at 420) a filter to the provided message. The filter may be used to select or identify messages, or portions of the messages, according to some filter criteria. For example, the S-CSCF may match or identify the SUBSCRIBE message according to filter criteria downloaded from the HSS. The S-CSCF may then forward the filtered SUBSCRIBE message to an application server (AS), as indicated by the arrow 425. The application server may confirm (at 430) that the provided message contains a valid request. For example, the application server may check (at 430) the validity of the XML request. If the request is valid, the application server may return a confirmation message to the mobile unit, as indicated by the arrow 435. For example, the application server may return a “200 OK” response to the mobile unit through the S-CSCF and the P-CSCF. The application server maps (at 440) the request provided by the mobile unit to a message that may be provided to the home subscription server. For example, the application server may map (at 440) an XML request to a Service-data-Request (UDR) message that may be provided over a Sh interface to the home subscription server. The application server may then provide the message to the home subscription server, as indicated by the arrow 445.

The home subscription server may query (at 450) a subscriber service database to locate and/or retrieve the requested service data. For example, home subscription server may query (at 450) a subscriber service database according to a User-Identity received in the UDR message. The home subscription server then provides a message including the retrieved service data to the application server, as indicated by the arrow 455. For example, the home subscription server may return a UDA (Service-data-Answer) message to the application server. The application server uses the provided message to form (at 460) a response message. For example, the application server may parse the UDA messages to determine the subscriber's services and/or service-data, and composes the service data and the allowed operations into an XML response, which may be sent (e.g., in a NOTIFY message) to the S-CSCF, as indicated by the arrow 465. The S-CSCF forwards the NOTIFY message to the P-CSCF, as indicated by the arrow 470, and the P-CSCF forwards the NOTIFY message to the mobile unit, as indicated by the arrow 475. The mobile unit parses the XML service response and displays (at 480) on the terminal interface of the mobile unit. The data operations may also be parsed and shown (at 480) on the terminal interface of the mobile unit.

In one alternative embodiment, the application server may have already requested the subscriber's service data, e.g. through the UDR and UDA messages. In this case, the application server may not need to confirm (at 430) the validity of the request and the home subscription server may not need to query (at 450) the database. Instead, the application server can respond directly to the service request by composing a response using locally stored service data that may have been previously retrieved from the home subscription server.

In one embodiment, the mobile unit may maintain the active subscription by periodically re-sending SUBSCRIBE message within a time period for subscription expiration. The SUBSCRIBE message may not contain an XML body. By periodically re-sending the SUBSCRIBE message, the mobile unit may receive notifications of any service data changes, as discussed in detail below. In one embodiment, the mobile unit may initiate subscription for service configuration upon power-on and may initiate un-subscription upon power-off.

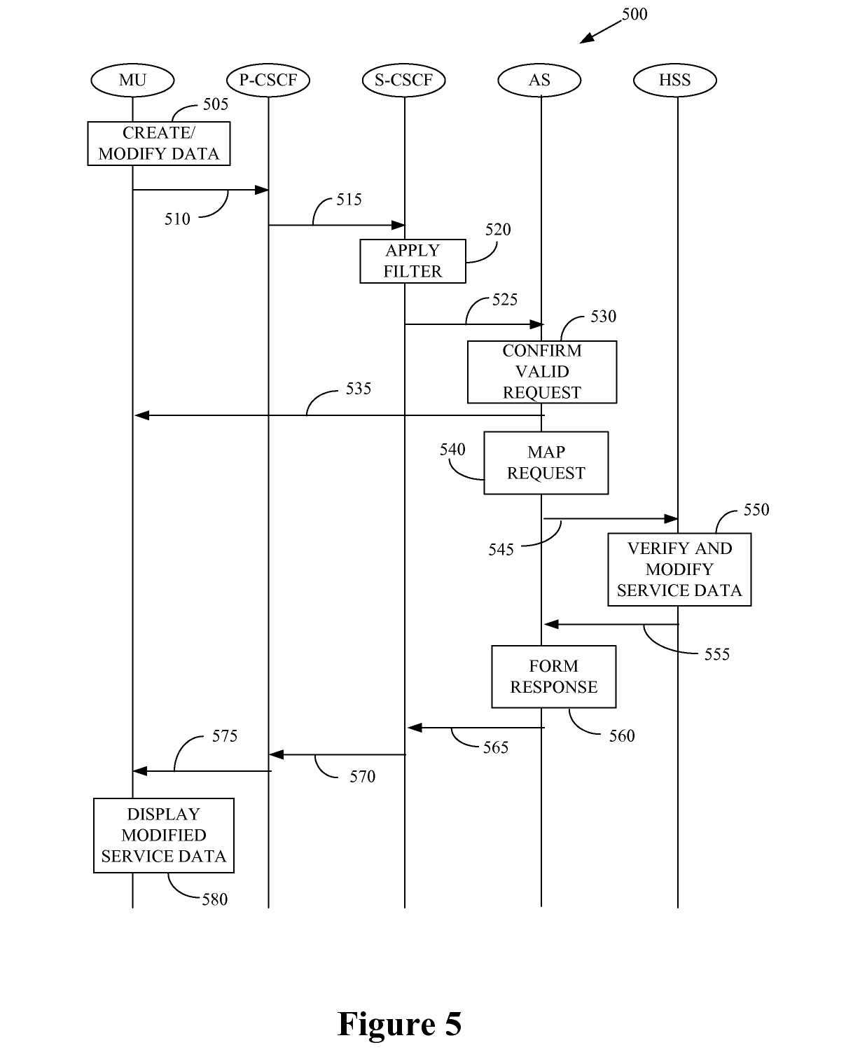

FIG. 5 conceptually illustrates one exemplary embodiment of a method 500 of modifying service data. In the illustrated embodiment, a subscriber (or end-user) creates and/or modifies (at 505) service data associated with one or more services that may be provided to the mobile unit (MU). For example, the subscriber may create and/or modify (at 505) service data by entering information into a service configuration graphical user interface on the mobile unit. The mobile unit may then provide a message containing information indicative of the created and/or modified service data to a P-CSCF, as indicated by the arrow 510. For example, the mobile unit may provide a service data modification request by sending out a SUBSCRIBE message including an XML request to the P-CSCF. The XML request may contain information indicative of the service to be modified, the service data and the operation to be performed at the home subscription server (e.g., add, modify or delete service data). The P-CSCF forwards the SUBSCRIBE message to assigned S-CSCF, as indicated by the arrow 515.

The S-CSCF may then apply (at 520) a filter to the provided message. For example, the S-CSCF may match the SUBSCRIBE message according to filter criteria downloaded from the HSS. The S-CSCF may then forward the filtered SUBSCRIBE message to an application server (AS), as indicated by the arrow 525. The application server may confirm (at 430) that the provided message contains a valid request. For example, the application server may check (at 530) the validity of the XML request. If the request is valid, the application server may return a confirmation message to the mobile unit, as indicated by the arrow 535. For example, the application server may return a “200 OK” response to the mobile unit through the S-CSCF and the P-CSCF. The application server maps (at 540) the request provided by the mobile unit to a message that may be provided to the home subscription server. For example, the application server may map (at 540) an XML request to a PUR (Profile-Update-Request) message that may be provided over a Sh interface to the home subscription server. The application server may then provide the message to the home subscription server, as indicated by the arrow 545.

The home subscription server may then verify (at 550) the service data information included in the message, e.g. the PUR message, and then modify (at 550) the service data using the information included in the message. For example, the home subscription server may access a service data profile associated with the mobile unit located in a database and update a portion of the service data using the information included in the message. The home subscription server provides a response indicating that the service data has been modified, as indicated by the arrow 555. For example, the home subscription server may return a PUA (Profile-Update-Answer) message to the application server. The result in the PUA message indicates if the modification was successful or not. The application server then parses (at 560) the PUA messages and translates (at 560) the result into an XML response that may be included in a NOTIFY message. The application server may then send the NOTIFY message to the S-CSCF, as indicated by the arrow 565, and the S-CSCF forwards the NOTIFY message to the P-CSCF, as indicated by the arrow 570. The P-CSCF may forward the NOTIFY message to the mobile unit, as indicated by the arrow 575. The mobile unit parses the XML service response and displays (at 580) the operation result on the terminal interface of the mobile unit.

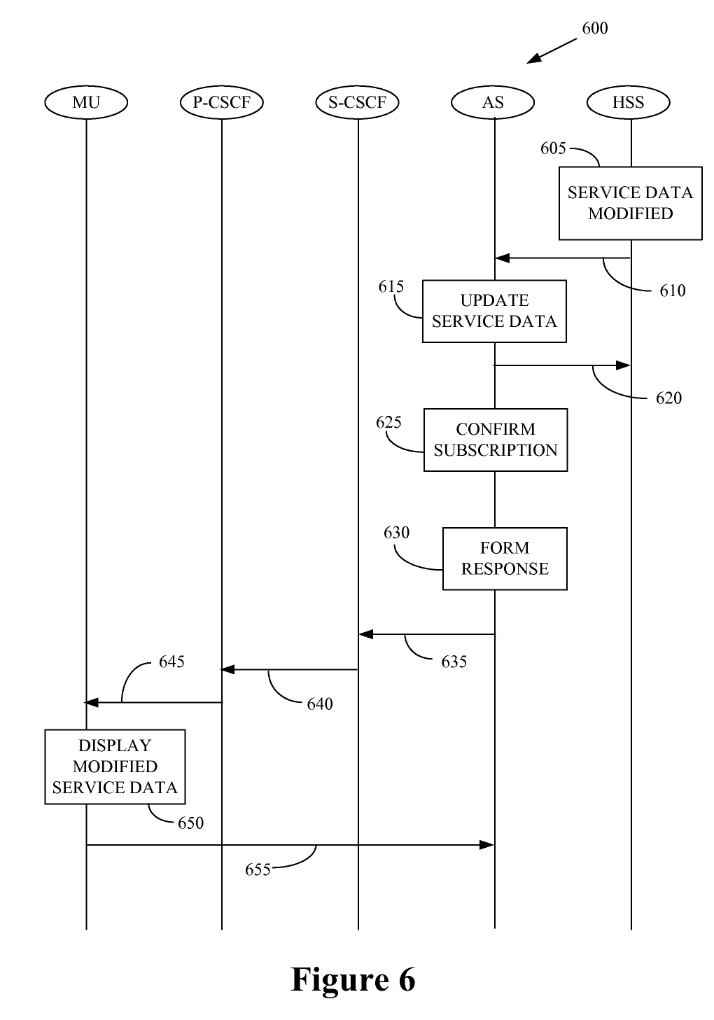

FIG. 6 conceptually illustrates one exemplary embodiment of a method 600 of notifying a mobile unit that service data has been modified. In the illustrated embodiment, the service data associated with the mobile unit and stored on the home subscription server is modified (at 605) by a device other than the mobile unit. For example, service provider personnel may modify (at 605) the service data. For other examples, the subscriber may access and/or modified (at 605) the service data using an operator help-desk, an interactive voice responder, a browser or web server, and the like. The home subscription server may then provide a message indicating that the service data has been modified, as indicated by the era 610. For example, the home subscription server may send a Profile-Update-Request (PUR) to the application server when the service data is modified by an external means.

The application server may then updates (at 615) the locally stored user service data using to the new data in the PUR message and then return a confirmation message to the home subscription server, as indicated by the arrow 620. For example, the application server may provide a Profile-Update-Answer (PUA) message to home subscription server. The application server may then confirm (at 625) that an active subscription is available for the mobile unit. If the mobile unit subscription for service configuration is still active, the application server may then form (at 630) a response including information indicative of the modified service data. For example, the application server may compose a NOTIFY message including the modified service data in the XML body of the NOTIFY message.

The application server may send the NOTIFY message to the S-CSCF, as indicated by the arrow 635, and the S-CSCF may forward the NOTIFY message to the P-CSCF, as indicated by the arrow 640. The P-CSCF then forwards the NOTIFY message to the mobile unit, as indicated by the arrow 645. The mobile unit may then display (at 650) information indicative of the modified service data. For example, the mobile unit may parse the XML body of the NOTIFY message, stores the new service data, and display (at 650) portions of the message on a user interface of the mobile unit to notify the subscriber that a service data change has occurred. The mobile unit may then provide a message confirming that the message was received, as indicated by the arrow 655. For example, the mobile unit may provide a “200 OK” message to acknowledge the receiving of the NOTIFY message.

The following are examples of the “service-config+xml” request/response messages that may be used in the embodiments discussed above:
Request to Query Service Data for Call Forwarding No Reply service (MU→IMS):

```
<?xml version=“1.0” encoding=“UTF-8”?>
  <service-config xmlns=“urn:ietf:params:xml:ns:service-config”
            xmlns:xsi=“http://www.w3.org/2001/XMLSchema-
            instance”>
    <request type=”Query” seqNum=”1”>
      <service>
        <serviceName>CallForwardingNoReply</serviceName>
      </service>
    </request>
  </service-config>
```

Service Data query results for Call Forwarding No Reply service:

```
<?xml version=“1.0” encoding=“UTF-8”?>
  <service-config xmlns=“urn:ietf:params:xml:ns:service-config”
            xmlns:xsi=“http://www.w3.org/2001/
            XMLSchema-instance”>
    <response type=”Query” seqNum=”1”>
      <service>
        <serviceName>CallForwardingNoReply</serviceName>
        <serviceData display=”Activate”>
          <radioButton value=”Yes” choice=”Yes,No”/>
          <operation changeAllowed=”yes” />
        </serviceData>
        <serviceData display=”ForwardTo” displayType=”TextInput”>
          <address>tom@home.com</address>
          <operation changeAllowed=”yes” />
        </serviceData>
      </service>
    </response>
  </service-config>
```

Modify Service Data—Request to changing Forward-to address:

```
<?xml version=“1.0” encoding=“UTF-8”?>
  <service-config xmlns=“urn:ietf:params:xml:ns:service-config”
            xmlns:xsi=“http://www.w3.org/2001/
            XMLSchema-instance”>
    <request type=”Modify” seqNum=”2”>
      <service>
        <serviceName>CallForwardingNoReply</serviceName>
        <serviceData>
          <address>tom@work.com</address>
        </serviceData>
      </service>
    </request>
  </service-config>
```

Modify Service Data Response

```
<?xml version=“1.0” encoding=“UTF-8”?>
  <service-config xmlns=“urn:ietf:params:xml:ns:service-config”
            xmlns:xsi=“http://www.w3.org/2001/
            XMLSchema-instance”>
    <response type=”Modify” seqNum=”2”>
      <service>
        <serviceName>CallForwardingNoReply</serviceName>
        <result>OK</result>
        <prompt>Forward-to Number Successfully Modified!</prompt>
      </service>
    </response>
  </service-config>
```

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
receiving, from the mobile unit, a request associated with information indicative of service data associated with a mobile unit; and
providing the request to a server that is configured to store the information indicative of the service data.

2. The method of claim 1, wherein receiving the request associated with the information indicative of the service data comprises receiving a subscription message provided by the mobile unit over a session initiation protocol (SIP) air interface.

3. The method of claim 2, wherein receiving the subscription message comprises receiving a subscription message associated with a service data event type.

4. The method of claim 3, wherein providing the request to the server comprises providing the request to the server over an interface according to an interface protocol.

5. The method of claim 4, wherein providing the request comprises mapping the request from the subscription message to the interface protocol.

6. The method of claim 5, comprising receiving a notification message from the server in response to providing the request.

7. The method of claim 6, comprising forming a response message based on the notification message.

8. The method of claim 7, comprising providing the response message to the mobile unit.

9. The method of claim 1, comprising providing at least one service to the mobile unit based on the service data.

10. A method, comprising:
providing, from a mobile unit, a request associated with information indicative of service data associated with the mobile unit; and
receiving a response message indicating that the information indicative of the service data has been provided to a server that is configured to store the information indicative of the service data.

11. The method of claim 10, wherein providing the request comprises providing a subscription message to a first entry node, the first entry node being configured to provide the information indicative of the service data to an application server.

12. The method of claim 11, wherein providing the subscription message comprises providing a subscription message associated with a service data event type.

13. The method of claim 12, wherein providing the information indicative of the service data to the server comprises providing the information indicative of the service data according to a session initiation protocol.

14. The method of claim 13, wherein receiving the response message comprises receiving the response message in response to a notification message being provided to the application server.

15. The method of claim 14, comprising accessing at least one service provided by the application server according to the service data.

16. The method of claim 10, comprising displaying information indicative of the service data using a user interface.

17. The method of claim 16, wherein providing the request comprises providing the request in response to user input provided via the user interface.
